(19) United States
(12) Patent Application Publication
(10) Pub. No.: US 2003/0043539 A1
(43) Pub. Date: Mar. 6, 2003

(54) Electronic apparatus

(75) Inventor: Satoshi Ooka, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/214,172

(22) Filed: Aug. 8, 2002

(30) Foreign Application Priority Data
Aug. 31, 2001 (JP) 2001-264065

(51) Int. Cl. G06F 1/16

(52) U.S. Cl. 361/685; 361/683

(57) ABSTRACT

A notebook-type personal computer of this invention uses three types of recording media, which are a CD-ROM, a smart-media card and an SD memory card. The personal computer comprises a main housing. The personal computer further comprises a CD-ROM unit, a smart-media card unit and an SD memory card unit, all incorporated in the main housing. The main housing has, in one side, a CD-ROM tray port, a SD memory card port and a smart-media card port. The CD-ROM unit, smart-media card unit and SD memory card unit are arranged such that the SD memory card port and a smart-media card port are located side by side and above the CD-ROM tray port.

### CROSS-REFERENCE TO RELATED APPLICATIONS

This application is based upon and claims the benefit of priority from the prior Japanese Patent Application No. 2001-264065, filed Aug. 31, 2001, the entire contents of which are incorporated herein by reference.

### BACKGROUND OF THE INVENTION

### FIELD OF THE INVENTION

The present invention relates to an electronic apparatus such as a notebook-type personal computer. More particularly, the invention relates to an electronic apparatus the unit-mounting area can be reduced without sacrificing the operability of each unit.

### DESCRIPTION OF THE RELATED ART

In recent years, notebook-type personal computers have found a wide use for their portability. Their functional efficiency is increasing day by day. For example, most notebook-type personal computers can use various recording media such as a smart-media card and a secure digital (SD) memory card, as well as a compact disc (CDs) and a digital versatile disc (DVDs).

It is demanded that notebook-type personal computers should not only perform various functions, but also be as small as desired. In view of this the layout of various units is very important.

Assume that a notebook-type personal computer comprises a CD-ROM unit, a smart-media card unit and an SD memory card unit. These units may generally be arranged in one of the following two alternative methods:

(1) The smart-media card unit and the SD memory card unit are laid one upon the other and are spaced far from the CD-ROM unit.

(2) The smart-media card unit, SD memory card unit and CD-ROM are arranged side by side, not overlapping one another.

If the units are arranged in the method (1), the smart-media card unit and the SD memory card unit cannot help but have notches of the same shape, which help the user to hold a recording medium. As a consequence, it will be difficult for the user to insert and remove a recording medium into and from one of these two units.

If the units are arranged in the method (2), they are located in the same plane, occupying a greater area than in the method (1). The area in which other components, such as the printed circuit board (PCB), are to be arranged will inevitably decrease.

### BRIEF SUMMARY OF THE INVENTION

The present invention has been made in view of the foregoing. An object of the invention is to provide an electronic apparatus in which the unit-mounting area can be reduced without sacrificing the operability of each unit.

To achieve the object, the present invention provide an electronic apparatus which comprises: a housing; a first port for inserting a disc, and provided to the housing; a second pot for inserting a first card, and located above the first port; and a third port for inserting a second card, and located above the first port and arranged side by side with the second port.

The electronic apparatus may incorporate, for example, a CD-ROM unit, a smart-media card unit and an SD memory card unit at the same time. In this case, the main housing has, in one side, a CD-ROM tray port, a smart-media card port and an SD memory card port. The CD-ROM unit, smart-media card unit and SD memory card unit are arranged in the main housing such that the smart-media card port and the SD memory card port are located side by side and above the CD-ROM tray port.

Since the three ports are so located, the smart-media card and the SD memory card can have two notches, respectively, which are different in size and shape. This make it easy for the user to insert and remove the smart-media card and the SD memory card into and from the smart-media card unit and the SD memory card unit, respectively. Additionally, this helps to make the apparatus small as a whole.

Additional objects and advantages of the invention will be set forth in the description that follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a perspective view of a notebook-type personal computer according to an embodiment of the present invention:

FIG. 2 is a side view of the notebook-type personal computer, showing the positional relation between the CD-ROM unit, SD memory card unit and smart-media card unit, all incorporated in the notebook-type personal computer;

FIG. 3 is a perspective view of a recording-medium unit, illustrating a finger rest cut in the a recording-medium unit; and

FIG. 4 is a perspective view of the notebook-type personal computer, showing the area occupied by the CD-ROM unit, SD memory card unit and smart-media card unit.

### DETAILED DESCRIPTION OF THE INVENTION

An embodiment of this invention will be described, with reference to the accompanying drawings.

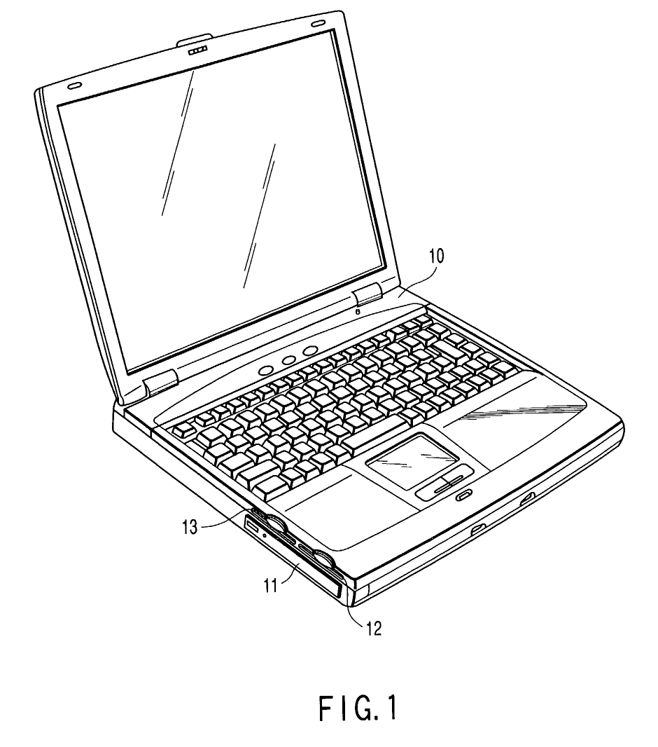

FIG. 1 is a perspective view of a notebook-type personal computer 10 according to an embodiment of the present invention.

The personal computer 10 can hold three recording media, which are a CD-ROM, a smart-media card and an SD memory card. As FIG. 1 shows, the personal computer 10 comprises a main housing. The left side of the main housing has a CD-ROM tray port 11. (Alternatively, the tray port 11 may be provided in the right side of the main housing.)

The personal computer 10 further comprises a CD-ROM unit, an SD memory card unit, and a smart-media card unit. The CD-ROM unit is held in the main housing and exposed through the CD-ROM tray port 11. The SD memory card unit and the smart-media card unit are provided in the main housing, too, and located side by side and above the CD-ROM unit.

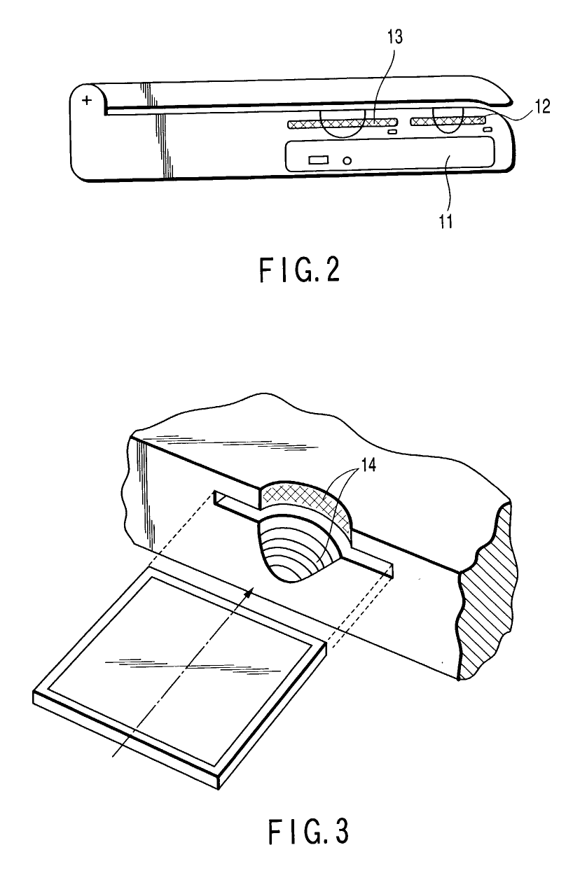

The left side of the main housing has an SD memory card port 12 and a smart-media card port 13. The ports 12 and 13 are located side by side and above the CD-ROM tray port 11. Hence, the ports 12 and 13 do no overlap at all. FIG. 2 is a side view of the personal computer 10, illustrating the positional relation between the CD-ROM tray port 11, SD memory card port 12 and smart-media card port 13.

Since the CD-ROM unit, SD memory card unit and smart-media card unit are so arranged as described above, each can have a so-called “finger rest,” or a notch, which is different from those of the other recording-medium units. FIG. 3 shows a recording-medium unit having a finger rest 14. The finger rest 14 has such a shape and size as would make it easy for the user to insert and remove the recording medium into and from the unit.

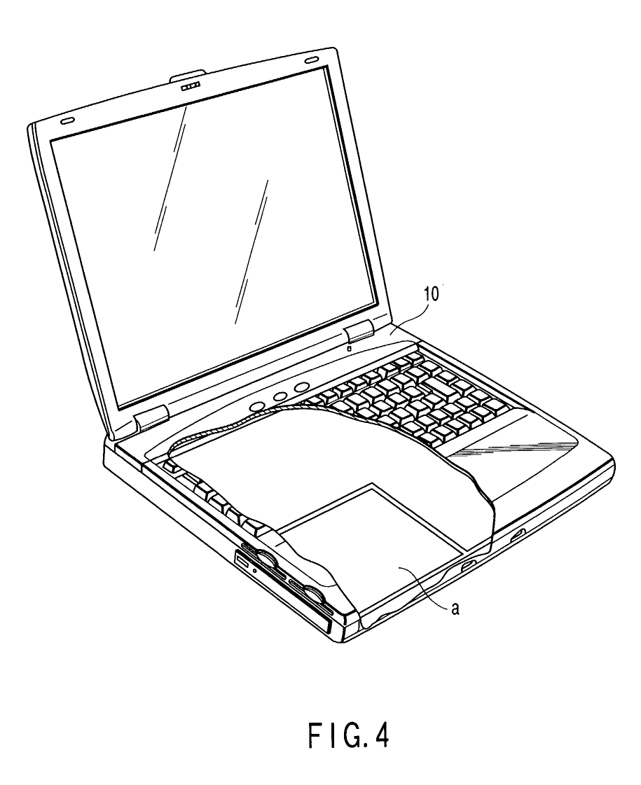

As described above, the smart-media card unit and the SD memory card unit are located above the CD-ROM unit. Hence, the CD-ROM unit, smart-media card unit and SD memory card unit occupy a smaller area than in the case where they are arranged side by side in the same plane. More precisely, as shown in FIG. 4, the smart-media card unit and the SD memory card unit occupy an area, which is about the same area as the CD-ROM unit occupies. This makes it easier to arrange other components, such as the printed circuit board (PCB), within the main housing of the notebook-type personal computer 10. Ultimately, the personal computer 10 can be small as a whole.

The CD-ROM unit may be arranged in the lower-left corner of the main housing (i.e., under the left half of the palm rest) as is illustrated in FIG. 1. If so arranged, the CD-ROM unit does not overlap the keyboard that is a relatively thick component. The main housing can, therefore, be made thinner than otherwise.

Thus, in the notebook-type personal computer according to the invention, the area in which all recording-medium units (i.e., the CD-ROM unit, smart-media card unit and the SD memory card unit) are mounted can be reduced without sacrificing their operability.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a housing;
a first port for inserting a disc, and provided to the housing;
a second port for inserting a first card, and located above the first port; and
a third port for inserting a second card, and located above the first port and arranged side by side with the second port.

2. The electronic apparatus according to claim 1, wherein the disc is a compact disc (CD).

3. The electronic apparatus according to claim 1, wherein the disc is a digital versatile disc (DVD).

4. The electronic apparatus according to claim 1, wherein the disc is a magneto-optical (MO) disc.

5. The electronic apparatus according to claim 1, wherein one of the first and second card is a flash memory card.

6. The electronic apparatus according to claim 1, wherein one of the first and second card is a smart-media card.

7. The electronic apparatus according to claim 1, wherein one of the first and second card is a compact flash card.

8. The electronic apparatus according to claim 1, wherein one of the first and second card is a secure digital (SD) memory card.

9. An electronic apparatus comprising:
a first unit to which a disc is inserted through a first port;
a second unit to which a first card is inserted through a second port located above the first port; and a third unit to which a second card is inserted through a third port located above the first port and arranged side by side with the second port.
